(19) United States
(12) Patent Application Publication
(10) Pub. No.: US 2019/0243163 A1
(43) Pub. Date: Aug. 8, 2019

(54) EYEGLASSES CLIP

(71) Applicant: Regina England, Atlanta, GA (US)

(72) Inventor: Regina England, Atlanta, GA (US)

(21) Appl. No.: 16/231,940

(22) Filed: Dec. 24, 2018

Related U.S. Application Data
(60) Provisional application No. 62/609,937, filed on Dec. 22, 2017.

(51) Int. Cl. G02C 11/02

(52) U.S. Cl. CPC G02C 11/02

(57) ABSTRACT

Implementations of an eyeglasses clip for attaching to and changing the appearance of eyeglasses are provided. In some implementations, the eyeglasses clip comprises a frame, eyeglasses lenses, and an attachment mechanism.

In some implementations, a method of using the eyeglasses clip comprises attaching the eyeglasses clip to the pair of eyeglasses, and wearing and using the eyeglasses with the attached eyeglasses clip.

### CROSS REFERENCE TO RELATED APPLICATION

This application claims the benefit of U.S. Patent Application Ser. No. 62/609,937, which was filed on Dec. 22, 2017, and is incorporated herein by reference in its entirety.

### TECHNICAL FIELD

This disclosure relates to implementations of an eyeglasses clip for attaching to and changing the appearance of eyeglasses.

### BACKGROUND

Existing clips for eyeglasses, such as prescription glasses, are often used to provide shaded lenses on top of clear lenses. For example, FIGS. 1A and 1B illustrate an example pair of existing clips for eyeglasses, which are also referred to as clip-ons or clip-on attachments. FIG. 1A is a front view of the clips attached to the eyeglasses. FIG. 1B is a back view of the clips attached to the eyeglasses. The existing clips include a frame and lenses. As shown, the lenses are shaded.

As shown in FIGS. 1A and 1B, the lenses of the existing clips are designed to cover the lenses of the eyeglasses. Also as shown, the lenses of the existing clips are intended to match as closely as possible the shape and size of the lenses of the underlying eyeglasses. Furthermore as shown, the frame of the existing clips are typically a thin metal frame that is designed to follow the contour of the frame of the eyeglasses.

Still further, as shown in FIGS. 1A and 1B, the existing attachment means on the clips that attach the clips to the frame of the eyeglasses are typically in the center of the clips and/or on the edges of the frame of the clips. As shown in FIG. 1A, the attachment means can be seen when the clips are placed on the eyeglasses.

Thus, existing clips are simply functional and are not designed to dramatically change the appearance of the frame of the underlying eyeglasses. Existing clips are also not designed to change the appearance of the shape of the lenses of the underlying eyeglasses. Furthermore, existing clips are not designed to conceal the attachment means when the clips are placed on the eyeglasses.

### BRIEF DESCRIPTION OF THE DRAWINGS

FIGS. 1A and 1B illustrate a front view and a back view respectively of an example pair of existing clips for eyeglasses.

FIG. 2 illustrates a front view of an implementation of an example eyeglasses clip according to the present disclosure attached to existing eyeglasses.

FIG. 3 illustrates a back perspective view of the example eyeglasses clip attached to the existing eyeglasses.

FIG. 4 illustrates a standalone back perspective view of the example eyeglasses clip.

### DETAILED DESCRIPTION

Implementations of an eyeglasses clip for attaching to and changing the appearance of eyeglasses are provided. In some implementations, the eyeglasses clip comprises a frame, eyeglasses lenses, and an attachment mechanism.

In some implementations, the eyeglasses clip is configured to transform or dramatically change the appearance of the frame of underlying eyeglasses, such as prescription glasses.

In some implementations, the eyeglasses clip is configured to change the appearance of the shape of the frame or the lenses of the underlying eyeglasses.

In some implementations, the eyeglasses clip is configured to conceal the attachment mechanism when the eyeglasses clip is attached to the underlying eyeglasses.

In some implementations, the eyeglasses clip is configured to change the appearance of any other suitable part of the underlying eyeglasses.

In some implementations, the eyeglasses clip is configured to conceal any other suitable part of the eyeglasses clip or the underlying eyeglasses.

In some implementations, a method of using the eyeglasses clip comprises attaching the eyeglasses clip to the pair of eyeglasses, and wearing and using the eyeglasses with the attached eyeglasses clip.

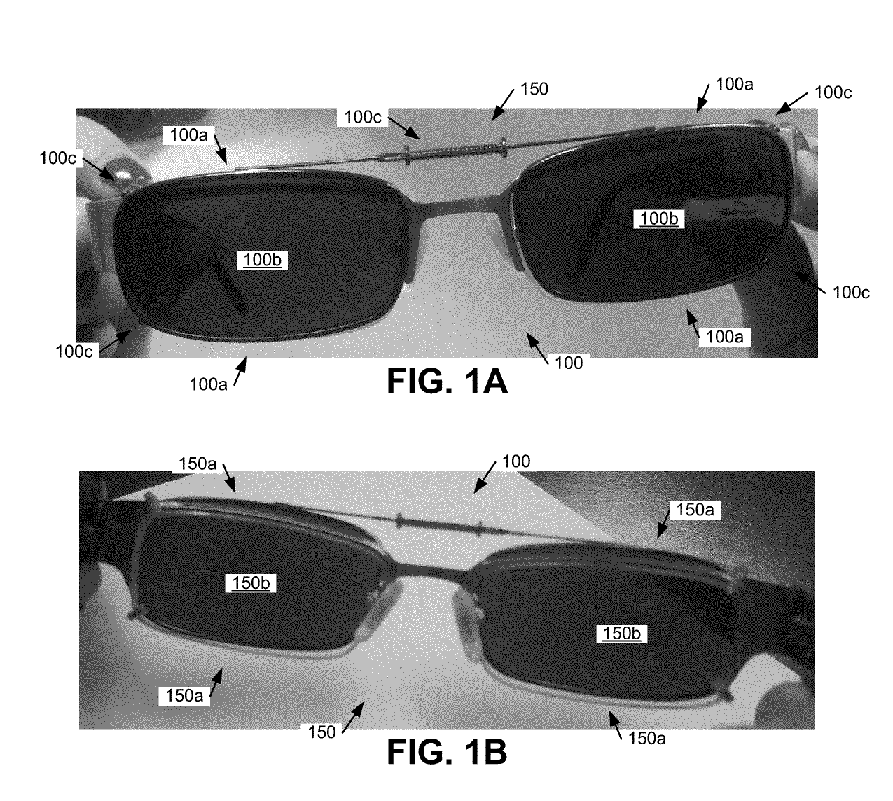

FIGS. 1A and 1B illustrate a front view and a back view respectively of an example pair of existing clips 100 for eyeglasses 150, such as prescription glasses. The existing clips 100, which are also referred to as clip-ons or clip-on attachments, are often used to provide shaded lenses on top of the clear lenses of the eyeglasses 150. The existing clips 100 include a frame 100a and lenses 100b. As shown, the lenses 100b are shaded.

As shown in FIGS. 1A and 1B, the lenses 100b of the existing clips 100 are designed to cover the lenses 150b of the eyeglasses 150. Also as shown, the lenses 100b of the existing clips 100 are intended to match as closely as possible the shape and size of the lenses 150b of the underlying eyeglasses 150. Furthermore as shown, the frame 100a of the existing clips 100 are typically a thin metal frame 100a that is designed to follow the contour of the frame 150a of the eyeglasses 150.

Still further, as shown in FIGS. 1A and 1B, the existing attachment means 100c on the existing clips 100 that attach the clips 100 to the frame 150a of the eyeglasses 150 are typically in the center of the clips 100 and/or on the edges of frame 100a of the clips 100. As shown in FIG. 1A, the attachment means 100c can be seen when the clips 100 are placed on the eyeglasses 150.

Thus, existing clips 100 are simply functional and are not designed to significantly change the appearance of the frame 150a of the underlying eyeglasses 150. Existing clips 100 are also not designed to change the appearance of the shape of the lenses 150b of the underlying eyeglasses 150. Furthermore, existing clips 100 are not designed to conceal the attachment means when the clips 100 are placed on the eyeglasses 150.

In some implementations, the eyeglasses clip 200 is configured to be attached to an existing pair of eyeglasses (“eyeglasses”) 250. In some implementations, the eyeglasses 250 may be the same or similar to the eyeglasses 150 referred to above.

In some implementations, the eyeglasses 250 may be any suitable type of eyeglasses. For example, in some implementations, the eyeglasses 250 may be prescription glasses, sunglasses, or safety glasses.

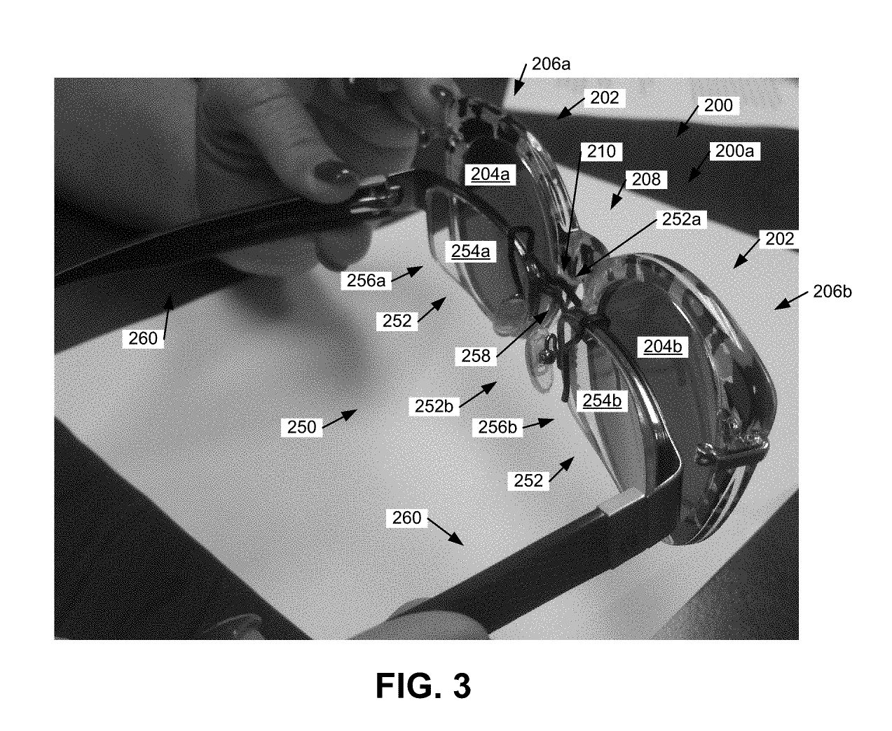

As shown in FIG. 3, existing eyeglasses 250 include a frame front 252, which may also be referred to as a front or a frame. The frame front 252 includes a left eyepiece 256a and a right eyepiece 256b, which may also be referred to as rims or eye wires. The eyepieces 256a, 256b are connected together by a bridge 258.

The eyeglasses 250 also include a left lens 254a and a right lens 254b that are attached to the frame front 252 at the left eyepiece 256a and the right eyepiece 256b respectively. The eyepieces 256a, 256b may fully, as shown in FIG. 3, or partially surround the perimeter of the lenses 254a, 254b for the attachment to the frame front 252.

The frame front 252 with or without the lenses 254a, 254b attached has an eyeglasses frame front structure. The left and right designation of the eyepieces 256a, 256b and the lenses 254a, 254b usually corresponds to the left and right eyes or side of the face of the user wearing the eyeglasses 250.

The eyeglasses 250 also include temples 260, which may also be referred to as arms or temple arms. The temples 260 are attached to the frame front 252 and support the eyeglasses 250 when worn by a user.

The eyeglasses 250 may also include other components, such as hinges that attach the temples to the frame front 252, which are not described and/or shown. Also, the combination of the frame front 252 and the temples 260 with or without the lenses 254a, 254b attached may also be referred to as an eyeglasses frame.

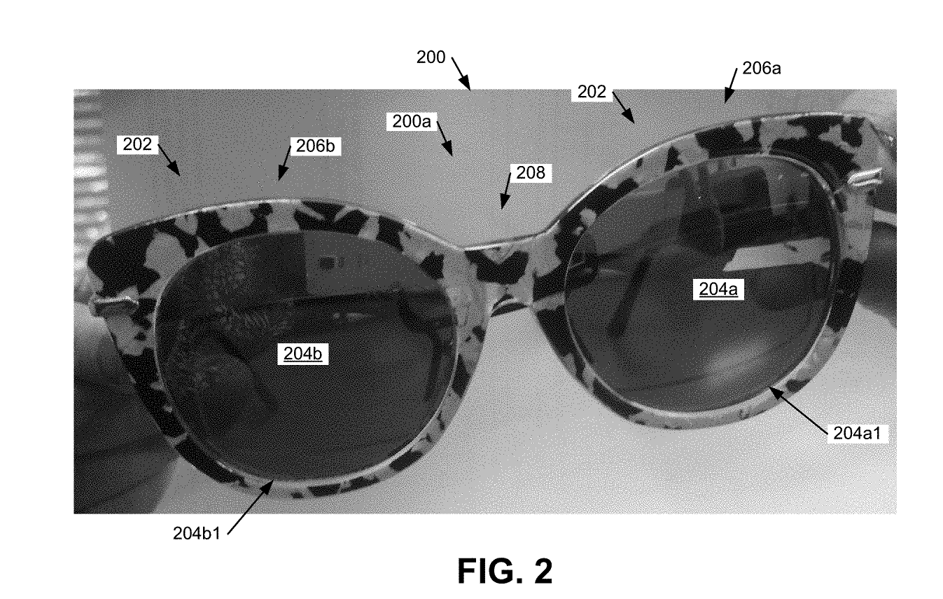

FIGS. 2-4 illustrate several views of an implementation of an example eyeglasses clip 200 according to the present disclosure.

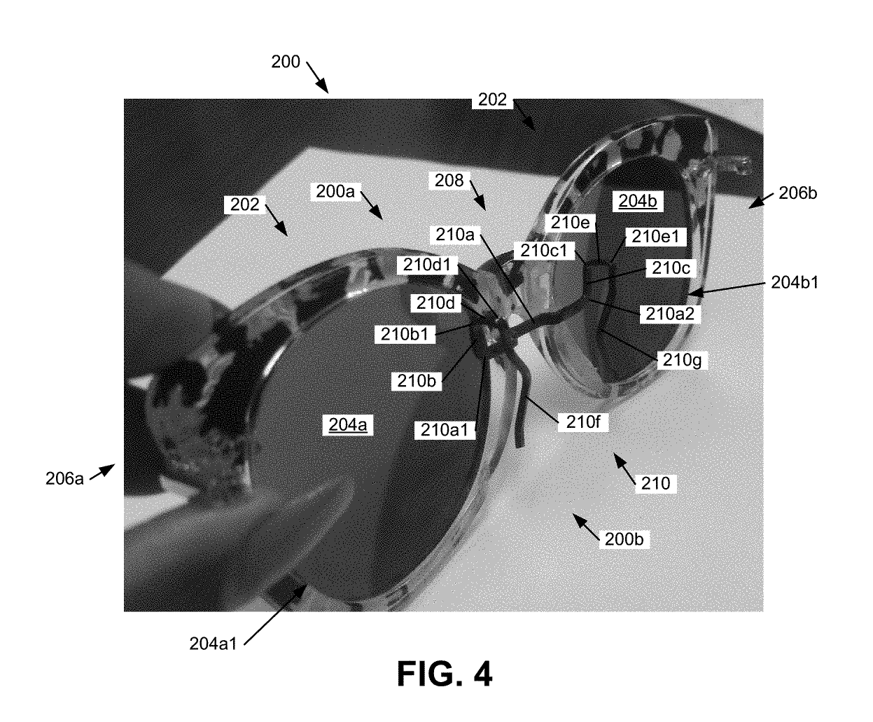

As shown in FIG. 4, in some implementations, the eyeglasses clip 200 comprises a frame 202, eyeglasses lenses (“lenses”) 204, and an attachment mechanism 210.

In some implementations, the frame 202 comprises a left eyeglasses eyepiece (“left eyepiece”) 206a, a right eyeglasses eyepiece (“right eyepiece”) 206b, and an eyeglasses bridge (“bridge”) 208. In some implementations, the eyepieces 206a, 206b are connected together by the bridge 208.

In some implementations, the lenses 204 comprise a left eyeglasses lens (“left lens”) 204a and a right eyeglasses lens (“right lens”) 204b. In some implementations, the left lens 204a and the right lens 204b are attached to the frame 202 at the left eyepiece 206a and the right eyepiece 206b respectively.

As shown in FIG. 4, in some implementations, the eyepieces 206a, 206b may fully surround the perimeter 204a1, 204b1 of the lenses 204a, 204b respectively for the attachment to the frame 202. In some implementations, the eyepieces 206a, 206b may partially surround the perimeter 204a1, 204b1 of the lenses 204a, 204b respectively for the attachment to the frame 202.

In some implementations, the lenses 204 of the eyeglasses clip 200 can be shaded or tinted. In some implementations, the lenses 204 can be colored.

In some implementations, the lenses 204 can be clear. In some implementations, the lenses 204 can have any other suitable quality.

In some implementations, the lenses 204 can have any other suitable appearance.

In some implementations, the attachment mechanism 210 comprises a thin clip that comprises several members.

In some implementations, the attachment mechanism 210 comprises a horizontal member 210a attached to the back side 200b of the frame 202 of the eyeglasses clip 200. In some implementations, the horizontal member 210a extends between the eyepieces 206a, 206b behind the bridge 208.

In some implementations, the attachment mechanism 210 comprises a left vertical member 210b extending upward from a left end 210a1 of the horizontal member 210a adjacent to the left eyepiece 206a.

In some implementations, the attachment mechanism 210 comprises a right vertical member 210c extending upward from a right end 210a2 of the horizontal member 210a adjacent to the right eyepiece 206b.

In some implementations, the attachment mechanism 210 comprises a left horizontal member 210d extending outward from a top end 210b1 of the left vertical member 210b away from the back side 200b of the eyeglasses clip 200.

In some implementations, the attachment mechanism 210 comprises a right horizontal member 210e extending outward from a top end 210c1 of the right vertical member 210c away from the back side 200b of the eyeglasses clip 200.

In some implementations, the attachment mechanism 210 comprises a second left vertical member 210f extending downward from an outer end 210d1 of the left horizontal member 210d opposite from the top end 210b1 of the left vertical member 210b.

In some implementations, the attachment mechanism 210 comprises a second right vertical member 210g extending downward from an outer end 210e1 of the right horizontal member 210e opposite from the top end 210c1 of the right vertical member 210c.

In some implementations, the left vertical member 210b, the left horizontal member 210d, and the second left vertical member 210f form a first inverted U-shaped portion of the thin clip of the attachment mechanism 210.

In some implementations, the right vertical member 210c, the right horizontal member 210e, and the second right vertical member 210g form a second inverted U-shaped portion of the thin clip of the attachment mechanism 210.

In some implementations, the first and second inverted U-shaped portions each securely attach onto the frame front 252 of the pair of eyeglasses 250.

In some implementations, the attachment mechanism 210 comprises any other suitable configuration.

As shown in FIG. 4, in some implementations, the attachment mechanism 210 is attached to the frame 202.

In some implementations, the attachment mechanism 210 is attached to the back side 200b of the frame 202 of the eyeglasses clip 200 between the eyepieces 206a, 206b and behind the bridge 208 to conceal the attachment mechanism 210.

In some implementations, the attachment mechanism 210 is attached to the frame 202 in any other suitable position or configuration.

In some implementations, the attachment mechanism 210 is reshapeable to adjust the attachment mechanism 210 to fit onto the frame front 252 of the pair of eyeglasses 250 to securely attach the eyeglasses clip 200 to the frame front 252. For example, in some implementations, the attachment mechanism 210 is composed of a material that can be re-shaped, e.g. bent, and hold the changed shape.

As shown in FIG. 3, in some implementations, the attachment mechanism 210 securely attaches the eyeglasses clip 200 to the frame front 252 of the pair of eyeglasses 250. In some implementations, the attachment mechanism 210 securely attaches the eyeglasses clip 200 to the frame front 252 so that the back side 200b of the eyeglasses clip 200 is positioned adjacent and aligned to the front side 252a of the frame front 252.

As shown in FIG. 4, in some implementations, the frame 202 and the lenses 204a, 204b attached to the frame 202 form an eyeglasses frame front structure. As shown in FIG. 3, in some implementations, the formed frame front structure, and thus the eyeglasses clip 200, is alignably positionable adjacent to the front side 252a of the frame front 252 of the pair of eyeglasses 250.

In some implementations, the front side 252a of the frame front 252 is opposite to the back side 252b of the frame front 252. In some implementations, the back side 252b of the frame front 252 positions adjacent to the face of a user wearing the pair of eyeglasses 250.

As shown in FIG. 3, in some implementations, the eyeglasses clip 200 is alignably positionable adjacent to the frame front 252 of the pair of eyeglasses 250 when the eyeglasses clip 200 is attached to the frame front 252 by the attachment mechanism 210. In some implementations, the eyeglasses clip 200 is alignably positionable adjacent to the frame front 252 so that the lenses 204a, 204b of the eyeglasses clip 200 at least partially align respectively with the lenses of the pair of eyeglasses 250.

In some implementations, the lenses 204a, 254a, 204b, 254b at least partially align respectively so that a user wearing the pair of eyeglasses 250 can respectively see through the lenses 204a, 254a, 204b, 254b to use the pair of eyeglasses 250 with the eyeglasses clip 200 attached to the pair of eyeglasses 250.

As shown in FIG. 2, in some implementations, the eyeglasses clip 200 conceals the frame front 252 of the pair of eyeglasses 250 when the eyeglasses clip 200 is attached to the frame front 252 by the attachment mechanism 210. In some implementations, the eyeglasses clip 200 conceals the frame front 252 when the eyeglasses clip 200 is viewed from a front view.

That is, in some implementations, the eyeglasses clip 200 conceals the frame front 252 when the user is viewed in a direction toward the front side 200a of the eyeglasses clip 200 while the user is wearing the pair of eyeglasses 250. In some implementations, the front side 200a of the eyeglasses clip 200 is opposite to the back side 200b of the eyeglasses clip 200.

As shown in FIG. 2, in some implementations, the attachment mechanism 210 is concealed by the eyeglasses clip 200 when the eyeglasses clip 200 is attached to the frame front 252 of the pair of eyeglasses 250 by the attachment mechanism 210. In some implementations, the attachment mechanism 210 is concealed when the eyeglasses clip 200 is viewed from a front view, such as described above with respect to the front side 200a of the eyeglasses clip 200 while the user is wearing the pair of eyeglasses 250.

As shown in FIG. 3, in some implementations, the shape of the eyeglasses clip 200 is independent of the shape of the frame front 252 of the pair of eyeglasses 250.

In some implementations, the shape of the eyeglasses clip 200 at least partially transforms the appearance of the shape of the frame front 252 of the pair of eyeglasses 250 when the eyeglasses clip 200 is attached to the frame front 252 by the attachment mechanism 210.

In some implementations, the shape of the eyeglasses clip 200 completely transforms the appearance of the shape of the frame front 252 of the pair of eyeglasses 250 when the eyeglasses clip 200 is attached to the frame front 252 by the attachment mechanism 210.

In some implementations, the shape of the eyeglasses clip 200 transforms the appearance of the shape of the frame front 252 of the pair of eyeglasses 250 when the eyeglasses clip 200 is viewed from a front view, such as described above with respect to the front side 200a of the eyeglasses clip 200 while the user is wearing the pair of eyeglasses 250.

In some implementations, any other suitable aspect of the eyeglasses clip 200 is independent and/or not a function of the frame front 252, the lenses 254a, 254b, or other components of the eyeglasses 250.

In some implementations, the eyeglasses clip 200 further comprises a color, a pattern, or an other decorative appearance. In some implementations, such decorative appearance(s) at least partially transforms the appearance of the front side 252a of the frame front 252 of the pair of eyeglasses 250 when the eyeglasses clip 200 is attached to the frame front 252 by the attachment mechanism 210.

In some implementations, such decorative appearance(s) completely transforms the appearance of the front side 252a of the frame front 252 of the pair of eyeglasses 250 when the eyeglasses clip 200 is attached to the frame front 252 by the attachment mechanism 210.

In some implementations, such decorative appearance(s) transforms the appearance of the front side 252a of the frame front 252 when the eyeglasses clip 200 is viewed from a front view, such as described above with respect to the front side 200a of the eyeglasses clip 200 while the user is wearing the pair of eyeglasses 250.

In some implementations, the eyeglasses clip 200 can comprise any other suitable decorative components. In some implementations, the eyeglasses clip 200 can comprise any other suitable appearance.

As shown in FIG. 2, in some implementations, the eyeglasses clip 200 is larger than the frame front 252 of the pair of eyeglasses 250 to conceal the front side 252a of the frame front 252. For example, in some implementations, the eyeglasses clip 200 is longer and/or wider than the frame front 252 of the eyeglasses 250.

In some implementations, the frame 202 of the eyeglasses clip 200 is configured to be larger than the frame front 252 of the eyeglasses 250. In some implementations, the lenses 204a, 204b of the eyeglasses clip 200 are configured to be larger than the lenses 254a, 254b of the eyeglasses 250.

In some implementations, the lenses 204a, 204b of the eyeglasses clip 200 are shaded, tinted, or colored to conceal the front side 252a of the frame front 252 of the pair of eyeglasses 250.

In some implementations, the eyeglasses clip 200 is configured to allow a user to use the eyeglasses 250 with the eyeglasses clip 200 attached to the eyeglasses 250.

In some implementations, the eyeglasses clip 200 is configured to transform the eyeglasses 250 to which the eyeglasses clip 200 is attached.

In some implementations, the eyeglasses clip 200 is configured to transform the eyeglasses 250 by dramatically changing the appearance of the underlying eyeglasses 250.

In some implementations, the eyeglasses clip 200 is configured to dramatically transform the appearance of the frame front 252 and/or lenses 254a, 254b of the eyeglasses 250 when the eyeglasses clip 200 is attached to the eyeglasses 250.

In some implementations, the frame 202 of the eyeglasses clip 200 is composed of a hard plastic.

In some implementations, the eyeglasses clip 200 is composed of any other suitable materials, such as the other examples described above.

In some implementations, the eyeglasses clip 200 can have any suitable dimensions.

In some implementations, the eyeglasses clip 200 can have any suitable appearance, such as the examples described above.

In some implementations, an example use of the eyeglasses clip 200 comprises attaching the eyeglasses clip 200 to the pair of eyeglasses 250 by securely attaching the attachment mechanism 210 to the frame front 252 of the pair of eyeglasses 250.

In some implementations, the example use further comprises a user wearing and using the pair of eyeglasses 250 with the eyeglasses clip 200 attached to the pair of eyeglasses 250. In some implementations, during such use, the eyeglasses clip 200 conceals the front side 252a of the frame front 252 of the pair of eyeglasses 250 and conceals the attachment mechanism 210 of the eyeglasses clip 200.

In some implementations, the eyeglasses clip 200 conceals the front side 252a during such use when the eyeglasses clip 200 is viewed from a front view. That is, in some implementations, the eyeglasses clip 200 conceals the frame front 252 when the user is viewed in a direction toward the front side 200a of the eyeglasses clip 200 while the user is wearing the pair of eyeglasses 250.

In some implementations, during such use, the shape of the eyeglasses clip 200 completely, or at least partially, transforms the appearance of the shape of the frame front 252 of the pair of eyeglasses 250 when the eyeglasses clip 200 is viewed from a front view, such as described above with respect to the front side 200a of the eyeglasses clip 200 while the user is wearing the pair of eyeglasses 250.

In some implementations, during such use, a decorative appearance of the eyeglasses clip 200 completely, or at least partially, transforms the appearance of the front side 252a of the frame front 252 of the pair of eyeglasses 250 when the eyeglasses clip 200 is viewed from a front view, such as described above with respect to the front side 200a of the eyeglasses clip 200 while the user is wearing the pair of eyeglasses 250.

In some implementations, during such use, the eyeglasses clip 200 dramatically transforms the appearance of the eyeglasses 250 and the attachment mechanism 210 is concealed.

In some implementations, another example use of the eyeglasses clip 200 comprises reshaping the attachment mechanism 210 to adjust the attachment mechanism 210 to fit onto the frame front 252 of the pair of eyeglasses 250.

In some implementations, the example use further comprises attaching the eyeglasses clip 200 to the pair of eyeglasses 250 by securely attaching the adjusted attachment mechanism 210 to the frame front 252 of the pair of eyeglasses 250.

The figures, including photographs and drawings, comprised herewith may represent one or more implementations of the eyeglasses clip.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. An eyeglasses clip for attaching to and changing the appearance of eyeglasses, comprising:
a frame comprising a left eyeglasses eyepiece and a right eyeglasses eyepiece connected together by an eyeglasses bridge;
a left eyeglasses lens and a right eyeglasses lens attached to the frame at the left eyeglasses eyepiece and the right eyeglasses eyepiece respectively, wherein the frame and the left eyeglasses lens and the right eyeglasses lens attached to the frame form an eyeglasses frame front structure that is alignably positionable adjacent to a front side of a frame front of a pair of eyeglasses that is opposite to a back side of the frame front that positions adjacent to the face of a user wearing the pair of eyeglasses; and
an attachment mechanism attached to the frame, wherein the attachment mechanism securely attaches the eyeglasses clip to the frame front of the pair of eyeglasses so that a back side of the eyeglasses clip is positioned adjacent and aligned to the front side of the frame front;
wherein:
the eyeglasses clip is alignably positionable adjacent to the frame front of the pair of eyeglasses when the eyeglasses clip is attached to the frame front by the attachment mechanism so that the left eyeglasses lens and the right eyeglasses lens of the eyeglasses clip at least partially align respectively with a left lens and a right lens of the pair of eyeglasses so that the user wearing the pair of eyeglasses can respectively see through the left lens and the left eyeglasses lens and through the right lens and the right eyeglasses lens to use the pair of eyeglasses with the eyeglasses clip attached to the pair of eyeglasses;
the eyeglasses clip conceals the frame front of the pair of eyeglasses when the eyeglasses clip is attached to the frame front by the attachment mechanism and the user is viewed in a direction toward a front side of the eyeglasses clip that is opposite to the back side of the eyeglasses clip while the user is wearing the pair of eyeglasses; and
the attachment mechanism is concealed by the eyeglasses clip when the eyeglasses clip is attached to the frame front by the attachment mechanism and the user is viewed in the direction toward the front side of the eyeglasses clip while the user is wearing the pair of eyeglasses.

2. The eyeglasses clip of claim 1, wherein:
the shape of the eyeglasses clip is independent of the shape of the frame front of the pair of eyeglasses; and
the shape of the eyeglasses clip completely transforms an appearance of the shape of the frame front of the pair of eyeglasses when the eyeglasses clip is attached to the frame front by the attachment mechanism and the user is viewed in the direction toward the front side of the eyeglasses clip while the user is wearing the pair of eyeglasses.

3. The eyeglasses clip of claim 1, wherein the eyeglasses clip further comprises a color, a pattern, or an other decorative appearance that completely transforms an appearance of the front side of the frame front of the pair of eyeglasses when the eyeglasses clip is attached to the frame front by the attachment mechanism and the user is viewed in the direction toward the front side of the eyeglasses clip while the user is wearing the pair of eyeglasses.

4. The eyeglasses clip of claim 1, wherein the eyeglasses clip is larger than the frame front of the pair of eyeglasses to conceal the front side of the frame front.

5. The eyeglasses clip of claim 1, wherein the left eyeglasses lens and the right eyeglasses lens of the eyeglasses clip are shaded, tinted, or colored to conceal the front side of the frame front of the pair of eyeglasses.

6. The eyeglasses clip of claim 1, wherein the attachment mechanism is attached to the back side of the frame of the eyeglasses clip between the left eyeglasses eyepiece and the right eyeglasses eyepiece and behind the eyeglasses bridge to conceal the attachment mechanism.

7. The eyeglasses clip of claim 1, wherein the attachment mechanism is reshapeable to adjust the attachment mechanism to fit onto the frame front of the pair of eyeglasses to securely attach the eyeglasses clip to the frame front.

8. The eyeglasses clip of claim 1, wherein the attachment mechanism comprises a thin clip comprising:
a horizontal member attached to the back side of the frame of the eyeglasses clip and extending between the left eyeglasses eyepiece and the right eyeglasses eyepiece behind the eyeglasses bridge;
a left vertical member extending upward from a left end of the horizontal member adjacent to the left eyeglasses eyepiece;
a right vertical member extending upward from a right end of the horizontal member adjacent to the right eyeglasses eyepiece;
a left horizontal member extending outward from a top end of the left vertical member away from the back side of the eyeglasses clip;
a right horizontal member extending outward from a top end of the right vertical member away from the back side of the eyeglasses clip;
a second left vertical member extending downward from an outer end of the left horizontal member opposite from the top end of the left vertical member; and
a second right vertical member extending downward from an outer end of the right horizontal member opposite from the top end of the right vertical member;
wherein the left vertical member, the left horizontal member, and the second left vertical member form a first inverted U-shaped portion of the thin clip and the right vertical member, the right horizontal member, and the second right vertical member form a second inverted U-shaped portion of the thin clip that each securely attach onto the frame front of the pair of eyeglasses.

9. A method of using the eyeglasses clip of claim 1, comprising attaching the eyeglasses clip to the pair of eyeglasses by securely attaching the attachment mechanism to the frame front of the pair of eyeglasses.

10. The method of claim 9, further comprising the user wearing and using the pair of eyeglasses with the eyeglasses clip attached to the pair of eyeglasses, whereby the eyeglasses clip conceals the front side of the frame front of the pair of eyeglasses and conceals the attachment mechanism of the eyeglasses clip when the user is viewed in the direction toward the front side of the eyeglasses clip while the user is wearing the pair of eyeglasses.

11. The method of claim 10, wherein the shape of the eyeglasses clip is independent of the shape of the frame front of the pair of eyeglasses, and whereby the shape of the eyeglasses clip completely transforms an appearance of the shape of the frame front of the pair of eyeglasses when the user is viewed in the direction toward the front side of the eyeglasses clip while the user is wearing the pair of eyeglasses.

12. The method of claim 10, wherein the eyeglasses clip further comprises a color, a pattern, or an other decorative appearance to transform an appearance of the front side of the frame front of the pair of eyeglasses, and whereby the eyeglasses clip completely transforms the appearance of the front side of the frame front when the user is viewed in the direction toward the front side of the eyeglasses clip while the user is wearing the pair of eyeglasses.

13. A method of using the eyeglasses clip of claim 7, comprising:
reshaping the attachment mechanism to adjust the attachment mechanism to fit onto the frame front of the pair of eyeglasses; and
attaching the eyeglasses clip to the pair of eyeglasses by securely attaching the attachment mechanism to the frame front.
